(19) United States
(12) Patent Application Publication
(10) Pub. No.: US 2007/0038458 A1
(43) Pub. Date: Feb. 15, 2007

(54) Apparatus and method for creating audio annotation

(75) Inventor: Jeong-choul Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/493,615

(22) Filed: Jul. 27, 2006

(30) Foreign Application Priority Data
Aug. 10, 2005 (KR) 2005-0073435

(51) Int. Cl. G10L 21/00

(52) U.S. Cl. 704/270

(57) ABSTRACT

An apparatus and method for creating an audio annotation are provided, in which audio information output corresponding to each of multimedia content files displayed in a group by a user is created and stored in a single file. An interface unit receives a selection command for at least one multimedia content file, an audio input unit receives an audio file corresponding to each of the multimedia content files selected according to the selection command, and an audio annotation creator creates an audio annotation file including the audio and link information between the audio and corresponding multimedia content file.

### CROSS-REFERENCE TO RELATED APPLICATION

This application claims the benefit under 35 U.S.C. § 119(a) of Korean Patent Application No. 10-2005-0073435 filed on Aug. 10, 2005 in the Korean Intellectual Property Office, the entire disclosure of which is hereby incorporated by reference.

### BACKGROUND OF THE INVENTION

1. Field of the Invention

The present invention relates to an apparatus and method for creating an audio annotation. More particularly, the present invention relates to an apparatus and method for creating a single file of audio information output corresponding to each of multimedia content file displayed in a group by a user and storing the file.

2. Description of the Related Art

Recent developments in technology allow laypersons to create multimedia content. In particular, with increased usage of personal computers (PCs) and shift from analog cameras to digital cameras, the number of users creating digital still images has rapidly increased.

Also, users are now creating digital moving pictures due to the introduction of camcorders.

In addition, the number of users creating digital moving pictures is increasing since the functions of digital cameras and camcorders are adapted to mobile phones.

Digital still images and digital moving pictures (hereinafter, referred to as multimedia content files) can be displayed in an apparatus in which the image and pictures are created, that is, a digital camera or a camcorder, and can also be displayed in a PC.

Users can digitize a still image created using an analog camera through a scanner and can display the still image in a PC.

When a multimedia content file is displayed on a PC, only still images or moving pictures may be displayed or played. Alternatively, words that have been input by a user may be displayed together with the still or moving pictures according to software.

Users can store audio files corresponding to multimedia content files that has been created and stored, and output the audio file output when the corresponding multimedia content file is displayed.

In other words, an audio file corresponding to the multimedia content file is created and then called and output when the corresponding multimedia content file is displayed.

When creating multimedia content files using devices such as digital cameras and camcorders, a user can input and store his/her own voice so that he/she can store ambient audio files occurring in his/her current situation in correspondence to the multimedia content files.

FIG. 1 is a conceptual diagram of the conventional corresponding relationship between multimedia contents and audio files. A plurality of multimedia content files 10 respectively correspond to a plurality of audio files 20.

For example, if a user inputs audio when creating a multimedia content file 10 using a digital camera, the input audio is stored in an audio file 20 in correspondence to the created multimedia content file 10. Here, the multimedia content file 10 and the audio file 20 may have the same file name so that a display apparatus can extract the audio file 20 having the same name as the multimedia content file 10 that the display apparatus is currently displaying.

The multimedia content files 10 and the audio files 20 are in a simple correspondence. In other words, a group of related multimedia content files 10 does not correspond to a single audio file 20.

For example, a user needs to create a corresponding audio file 20 whenever he or she wants to create each of a plurality of related multimedia content files 10 while taking the relationship between the multimedia content files 10 into consideration.

Japanese Patent Publication No. 2004-297424 discloses a digital camera for easily providing a slide display of still images with audio by combining a plurality of recorded still images with audio.

The digital camera stores a plurality of audio files and a plurality of corresponding still images in a single file, that is, an audio video interleaved (AVI) file so that when the AVI file is played, a still image is displayed while a corresponding audio file is output.

Here, a still image may be inserted into an AVI file in one second units. Based on this feature, a user can input short or long audio information. For example, a user can insert 5-second audio information for a still image and 10-second audio information for another still image.

Consequently, the digital camera stores a plurality of audio files corresponding to a plurality of still images in a single AVI file and replays the AVI file. According to this digital camera, many copies of a single still image need to be included in an AVI file.

For example, when 5-second audio information is inserted for a still image, the still image is copied and five files of the still image are stored in the AVI file. This incurs unnecessary waste of resources.

Moreover, since multiple still images are inserted into a single file, editing the multiple still images inserted into a single file is quite difficult.

Accordingly, a need exists for a method of storing audio information for a plurality of multimedia content files grouped by a user and outputting audio information corresponding to each multimedia content file currently displayed.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for creating and storing in a single file audio information output in correspondence to individual multimedia content files grouped by a user.

The above stated object as well as other objects, features and advantages, of the present invention will become clear to those skilled in the art upon review of the following description.

According to an aspect of exemplary embodiments of the present invention, there is provided an apparatus for creating an audio annotation, in which an interface unit receives a selection command for at least one multimedia content file, an audio input unit receives an audio file corresponding to each of the multimedia content files selected according to the selection command, and an audio annotation creator creates an audio annotation file including the audio.

According to another aspect of exemplary embodiments of the present invention, there is provided a method of creating an audio annotation, in which a selection command is received for at least one multimedia content file, an audio file corresponding to each of the multimedia content file selected is received according to the selection command, and an audio annotation file including the audio is created.

According to a further aspect of exemplary embodiments of the present invention, there is provided a computer readable recording medium comprising a computer program for executing a method of creating an audio annotation.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings in which:

FIG. 1 is a conceptual diagram of the conventional corresponding relationship between multimedia content and audio files;

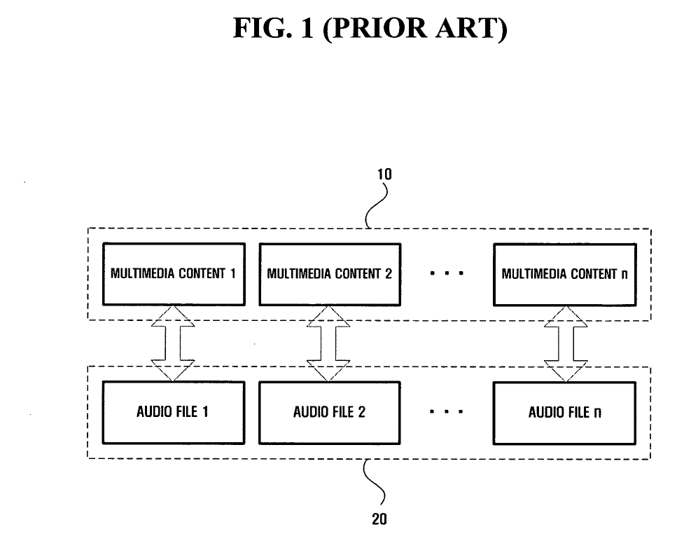

FIG. 2 is a block diagram of an apparatus for creating an audio annotation according to an exemplary embodiment of the present invention;

FIG. 3 illustrates a format of an audio annotation file according to an exemplary embodiment of the present invention;

FIGS. 4A through 4C illustrate the structures of directories in which a multimedia content file and an audio annotation file are stored according to an exemplary embodiment of the present invention;

FIG. 5 illustrates a graphical user interface which receives a title of an audio annotation album according to an exemplary embodiment of the present invention;

FIG. 6 illustrates a graphical user interface which receives a selection command for a multimedia content file according to an exemplary embodiment of the present invention;

FIG. 7 illustrates a graphical user interface which receives a setup command for a playing sequence of multimedia content files according to an exemplary embodiment of the present invention;

FIGS. 8A and 8B illustrate graphical user interfaces displayed during audio recording according to an exemplary embodiment of the present invention;

FIG. 9 illustrates a graphical user interface displaying a list of created audio annotation files according to an exemplary embodiment of the present invention;

FIG. 10 illustrates a graphical user interface displayed when multimedia content and audio files are output according to an exemplary embodiment of the present invention;

FIG. 11 illustrates a graphical user interface which allows a created audio annotation file to be edited according to an exemplary embodiment of the present invention; and

FIG. 12 is a flowchart of a method of creating an audio annotation according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The present invention will be described exemplary embodiments of the invention hereinafter with reference to flowchart illustrations of methods.

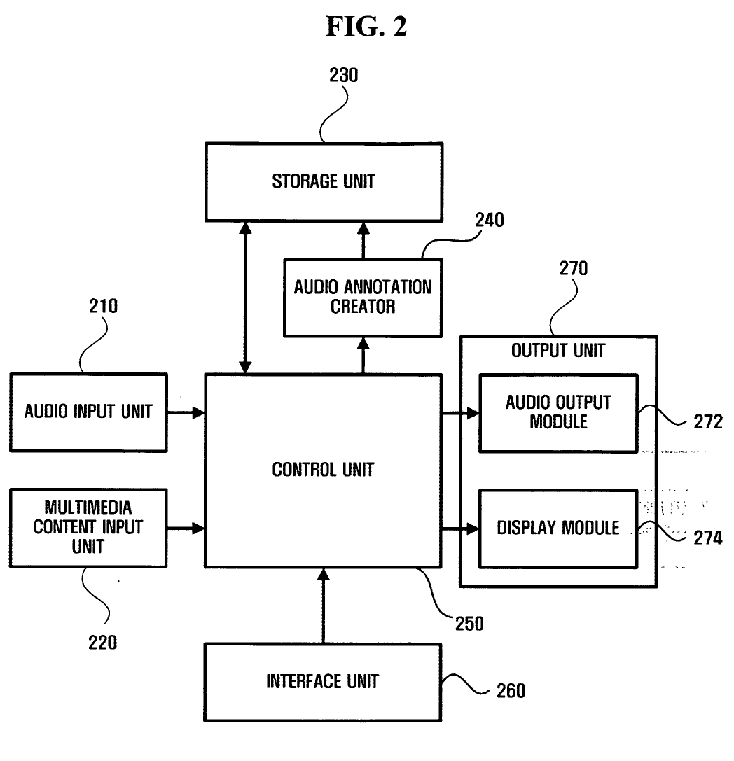

Referring to FIG. 2, an apparatus for creating an audio annotation according to an exemplary embodiment of the present invention (hereinafter, referred to as an apparatus) includes an audio input unit 210, a multimedia content input unit 220, a storage unit 230, an audio annotation creator 240, a control unit 250, an interface unit 260, and an output unit 270.

The apparatus creates a single audio annotation file according to an exemplary embodiment of the present invention for a plurality of multimedia content files. Here, the multimedia content files may be still images or moving pictures.

Accordingly, the apparatus may include a unit for receiving a user's voice, a unit for storing a multimedia content file and a created audio annotation file, and a unit for outputting a multimedia content file and audio file corresponding to the multimedia content file. Such apparatus may be a digital camera, a camcorder, or at least one of a mobile phone, a personal digital assistant (PDA), a personal computer (PC), and the like having functions of the digital camera or the camcorder.

The storage unit 230 stores multimedia content files and an audio annotation file combining audio files corresponding to the multimedia content files.

As described above, the multimedia content files may be still images or moving pictures. The audio annotation file may include information on a multimedia content file and a corresponding audio file. For example, the audio annotation file includes audio data and link information regarding a multimedia content file but does not include multimedia content file data. Accordingly, the apparatus or a separate output device outputs the multimedia content file and a corresponding audio using the link information.

Since the multimedia content file is not included in the audio annotation file, a user can freely edit the multimedia content file.

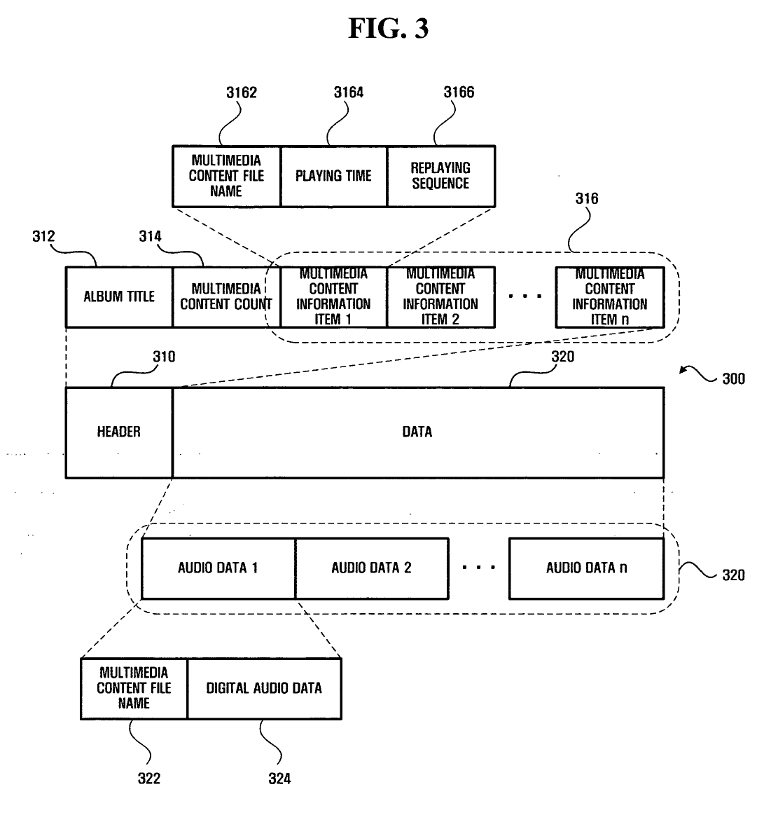

The audio annotation file will be described in detail with reference to FIG. 3 later.

The storage unit 230 may be implemented as, but not limited to, a module such as a hard disc, a flash memory, a compact flash (CF) card, a secure digital (SD) card, a smart media (SM) card, a multimedia card (MMC), or a memory stick, which can input and output information. It may be included within the apparatus or included in a separate device.

The multimedia content input unit 220 receives a multimedia content photographed by the apparatus or stored in a separate external device. Accordingly, the apparatus may include an imaging device such as a complimentary metal-oxide semiconductor (CMOS) device or a charge coupled device (CCD), a decoder converting an analog multimedia content file into a digital multimedia content file, and a communication unit for communicating with an external device.

The communication unit may use a wired communication mode such as Ethernet, Universal Serial Bus (USB), Institute of Electrical and Electronics Engineers (IEEE) 1394, serial communication, or parallel communication and/or a wireless communication mode such as infrared communication, Bluetooth, HomeRF, or wireless local area network (LAN).

A multimedia content file received by the multimedia content input unit 220 is stored in the storage unit 230.

The interface unit 260 receives a selection command for selecting at least one multimedia content file. When selecting a multimedia content file corresponding to an audio annotation to be created, a user can input the selection command for selecting the multimedia content file to be linked to an audio file from among a plurality of multimedia content files stored in the storage unit 230 using the interface unit 260.

The interface unit 260 is a device which can receive the user's commands and may be implemented as a button, a wheel, a sensor, or a touch screen in the apparatus.

When the apparatus includes a display unit and displays a graphical user interface through the display unit, a user can input a selection command for a multimedia content file through the graphical user interface using buttons provided in the apparatus.

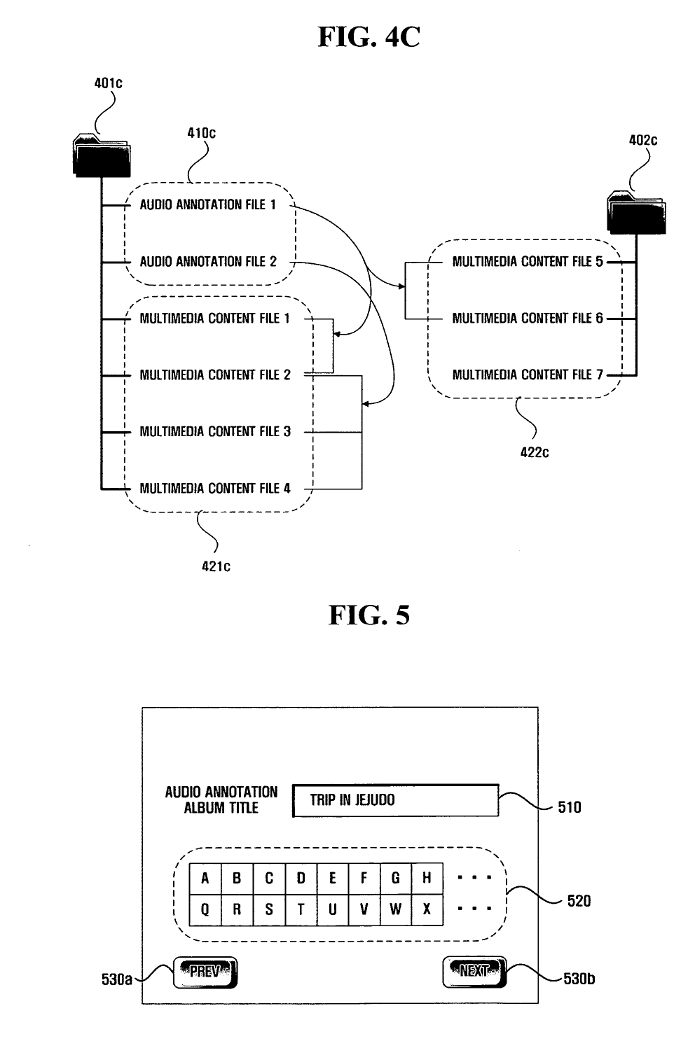

In addition, the interface unit 260 can also receive other additional commands from the user. A detailed description will later be set forth with reference to FIGS. 6.

The audio input unit 210 receives an audio file corresponding to a multimedia content file selected by the selection command. In other words, the audio input unit 210 receives a user's voice. Accordingly, the apparatus may include a decoder which converts analog data of the user's voice to digital data. The digital audio data is transmitted to the audio annotation creator 240.

The audio annotation creator 240 creates an audio annotation file including at least one input audio file. A user can input a single audio file corresponding to a single multimedia content file. The audio annotation creator 240 combines a plurality of input audio files to create an audio annotation file. The audio annotation creator 240 can be implemented as a program code module for the control unit 250 or a separate processor (not shown) provided in the audio annotation creator 240. Alternatively, the audio annotation creator 240 can be a field programmable gate array (FPGA) or complex programmable logic device (CPLD).

Audio data may be stored in the audio annotation file in correspondence to multimedia content files according to a playing sequence by storing the audio data according to the playing sequence or respectively matching multimedia content files with the audio data. When storing the audio data according to the playing sequence, the apparatus determines the playing sequence of the multimedia content files before creating the audio annotation file, receives audio files from the user according to the playing sequence, and creates the audio annotation file.

Alternatively, when matching the multimedia content file with the audio data, the apparatus adds information on a multimedia content file to corresponding audio data to create the audio annotation file. For example, a file name of a multimedia content file may be added to the front of corresponding audio data so that the audio data is matched with the multimedia content file. Thereafter, when replaying a multimedia content file, the apparatus can extract audio data corresponding to the multimedia content file using the file name of the multimedia content file. The audio annotation file created by the audio annotation creator 240 is stored in the storage unit 230.

The output unit 270 outputs a multimedia content file and an audio file corresponding thereto, which are stored in the storage unit 230. The output unit may output the multimedia content file and the audio file according to a playing time and a playing sequence included in an audio annotation file. In detail, the audio annotation file is analyzed by the control unit 250 and the control unit 250 controls the output unit 270 to output according to the playing time and the playing sequence included in an audio annotation file.

To output multimedia content files and audio files, the output unit 270 may include a display module 274 and an audio output module 272.

The display module 274 may include an image display device such as a cathode ray tube (CRT), a liquid crystal display (LCD), a light emitting diode (LED), an organic light emitting diode (OLED), or a plasma display panel (PDP), which can display an input image signal, and displays multimedia content files. As described above, the multimedia content files may be still images or moving pictures. Accordingly, the apparatus may include a still image decoder and a moving picture decoder.

The audio output module 272 outputs an analog audio file corresponding to audio data included in an audio annotation file. For this operation, the apparatus may include a converter which converts digital audio data to analog audio data.

The control unit 250 controls the audio input unit 210, the multimedia content input unit 220, the storage unit 230, the audio annotation creator 240, the interface unit 260, and the output unit 270 and controls the apparatus overall. Program code for implementing the present invention such as the operations or the control unit 250 in connection with devices connected thereto and the audio annotation creator 240 can be stored, for example, in the storage unit 230 as computer-readable codes on a computer-readable medium. The computer-readable recording medium is any data storage device that can store data which can thereafter be read by a computer system. Examples of the computer-readable recording medium include, but are not limited to, read-only memory (ROM), random-access memory (RAM), CD-ROMs, magnetic tapes, floppy disks, optical data storage devices, and carrier waves (such as data transmission through the Internet via wired or wireless transmission paths). The computer-readable recording medium can also be distributed over network-coupled computer systems so that the computer-readable code is stored and executed in a distributed fashion. Also, functional programs, codes, and code segments for accomplishing the present invention can be easily construed as within the scope of the invention by programmers skilled in the art to which the present invention pertains.

FIG. 3 illustrates a format of an audio annotation file according to an exemplary embodiment of the present invention.

An audio annotation file 300 includes a header area 310 and data area 320. The audio annotation file 300 may be created as a single file for a single album of a plurality of selected multimedia content files.

The header area 310 includes an album title field 312, a multimedia content count field 314, and a multimedia content information field 316. The multimedia content information field 316 includes a multimedia content file name field 3162, a playing time field 3164, and a playing sequence field 3166.

The album title field 312 includes text information input by a user. An album title is information that can be displayed through the display module 274 when a multimedia content file and an audio file included in the audio annotation file 300 are output. The album title may be automatically set to be the same as a name of the audio annotation file 300 and may be changed by the user. In a case where the album title is set to be the same as the name of the audio annotation file 300, when the user changes the name of the audio annotation file 300, the album title may be changed simultaneously.

The multimedia content count field 314 includes the number of all multimedia content files including still images and moving pictures selected by the user. When the multimedia content files are displayed through the display module 274, the number of multimedia content files may be displayed together with the multimedia content files and may be used to determine the number of audio data items included in the data area 320 of the audio annotation file 300.

In other words, the file name of a multimedia content file, a playing time, and a playing sequence are stored as an information item on a single multimedia content file in the header area 310. The number of multimedia content information items as the multimedia content files selected by the user are present. Here, the control unit 250 can recognize the number of multimedia content information items included in the header area 310 based on the number of multimedia content files, which is stored in the multimedia content count field 314, and can extract audio data items from the data area 320.

The multimedia content file name field 3162 includes the file name of a multimedia content file among the multimedia content files selected by the user. The file name may include an extension so that the control unit 250 can determine whether the multimedia content file is a still image or a moving picture and perform digital conversion.

The control unit 250 checks the file name of a multimedia content file, extracts a multimedia content file having the same file name from the storage unit 230, and displays the multimedia content file through the display module 274.

The control unit 250 searches a directory storing the audio annotation file 300 to extract the multimedia content file. To allow the control unit 250 to extract the multimedia content file which may be stored in a different directory, a storage path as well as the file name of the multimedia content file may also be included in the multimedia content file name field 3162.

The playing time field 3164 includes a playing time during which a multimedia content file and a corresponding audio file are output.

The playing time may be set in seconds. The playing time may be determined by a user when the audio annotation file 300 is created. When the playing time is automatically input, the same duration is set for all multimedia content file. For example, if the user sets the playing time to 10 seconds, an audio for each multimedia content file can be input for 10 seconds.

When the playing time is manually input, different durations may be set for multimedia content files. For example, a user can input an audio file as long as he/she desires for a multimedia content file when creating the audio annotation file 300. Duration while the input audio is played, that is, a playing time, is stored in the playing time field 3164.

The replaying sequence field 3166 includes a playing sequence in which a multimedia content file and a corresponding audio file are output. The control unit 250 extracts the multimedia content file and the audio file according to the playing sequence stored in the playing sequence field 3166. The playing sequence may be determined when the audio annotation file 300 is created and may be changed by a user.

The data area 320 includes a multimedia content file name field 322 and a digital audio data field 324. In other words, a plurality of digital audio data and file names of corresponding multimedia content files are stored in the data area 320.

A file name stored in the multimedia content file name field 322 included in the data area 320 may be the same as a file name stored in the multimedia content file name field 3162 included in the header area 310, so that the control unit 250 may extract digital audio data according to the playing sequence.

In detail, the digital audio data may not be arranged according to the playing sequence in the data area 320. In this situation, the control unit 250 can extract digital audio data corresponding to a multimedia content file based on the playing sequence field 3166 included in the header area 310.

Storing a file name of a multimedia content file in the data area 320 may unnecessarily waste memory. To prevent such unnecessary waste of memory, a multimedia content file ID field instead of the multimedia content file name field 322 may be included in the data area 320 and another multimedia content file ID field may be added to the header area 310. In this case, the size of the audio annotation file 300 can be decreased. For example, the file name of a multimedia content file may occupy about 200 through 500 bytes of memory. When this file name is converted to a multimedia content file ID occupying 1 through several bytes, the waste of memory can be decreased.

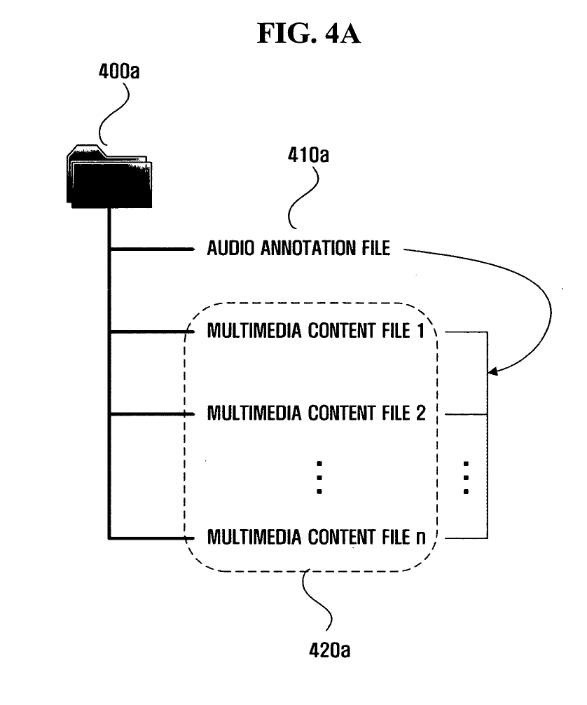

FIGS. 4A through 4C illustrate the structures of directories in which a multimedia content file and an audio annotation file are stored according to an exemplary embodiment of the present invention. Referring to FIG. 4A, a single audio annotation file 410a and a plurality of multimedia content files 420a are stored in a single directory 400a.

The audio annotation file 410a stores multimedia content file information (for example, a multimedia content file name, a multimedia content file storage path, a playing time, and a playing sequence) on each of the multimedia content files 420a. The control unit 250 extracts a multimedia content file 420a and corresponding digital audio data based on the multimedia content file information included in the audio annotation file 410a. Here, when the multimedia content file information includes a multimedia content file name, the control unit 250 searches for the multimedia content file 420a using the multimedia content file name in the directory 400a storing the audio annotation file 410a.

Accordingly, the multimedia content files 420a and the corresponding audio annotation file 410a may be stored in one directory 400a so that multimedia content files and audio files are output in accordance with an audio annotation album.

A user can select at least one multimedia content file 420a from among the plurality of the multimedia content files 420a stored in the directory 400a. If a multimedia content file is not present in the directory 400a while the multimedia content file and a corresponding audio file are output, the output of the multimedia content file and the audio file may be omitted.

Referring to FIG. 4B, a plurality of audio annotation files 410b and a plurality of multimedia content files 420b are stored in a single directory 400b. Each of the audio annotation files 410b may refer to a plurality of multimedia content files 420b selected by a user and a single multimedia content file 420b may be referred to by the plurality of audio annotation files 410b.

Referring to FIG. 4C, a plurality of audio annotation files 410c and a plurality of multimedia content files 421c and 422c are separately stored in a plurality of directories 401c and 402c.

When a multimedia content file name is included as multimedia content file information in each of the audio annotation files 410c, the control unit 250 can search for a particular multimedia content file 421c using the file name. The searching is performed on the directory 401c storing the audio annotation files 410c.

However, to allow the directory 402c that does not store the audio annotation files 410c to be searched for a multimedia content file 422c, as shown in FIG. 4C, a multimedia content file storage path may be included as the multimedia content file information in each audio annotation file 410c. In this situation, the control unit 250 can search for the multimedia content file 422c stored in the directory 402c in which the audio annotation files 410c are not stored.

As described above, the apparatus may include the display module 274. A user can input information on the audio annotation file 300 through a graphical user interface displayed in the display module 274. The user can select a menu item for setting the audio annotation file 300 from a command list displayed through the graphical user interface. The command list may be divided into a creation item used to create the audio annotation file 300 (referred to as) and a management item used to manage the audio annotation file 300.

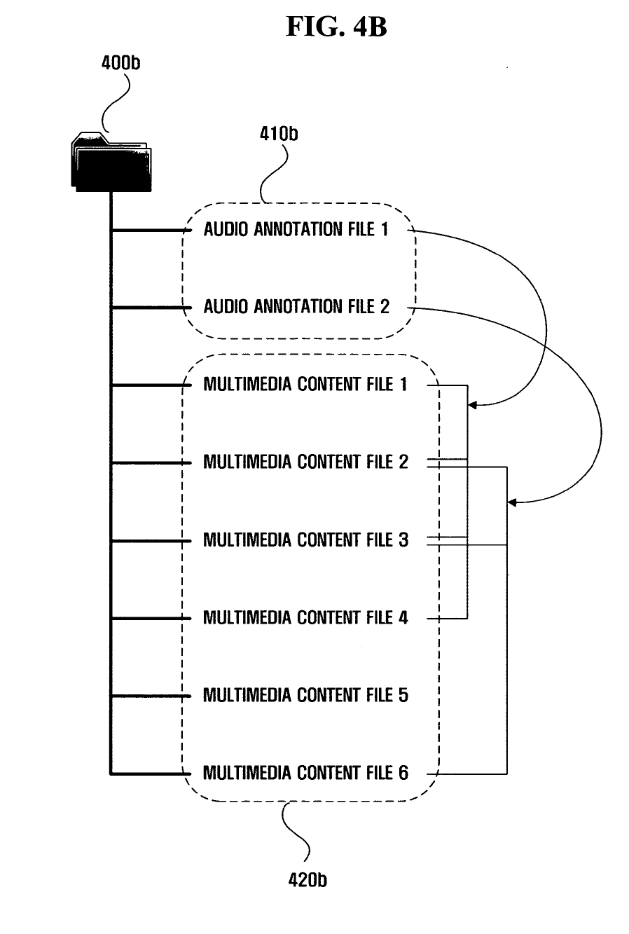

FIGS. 5 through 8B illustrate graphical user interfaces 500, 600, 700, 800a, and 800b in stages of creating the audio annotation file 300. The graphical user interfaces 500, 600, 700, 800a, and 800b are displayed when the creation item is selected from the command list.

FIG. 5 illustrates a graphical user interface which receives a title of an audio annotation album according to an exemplary embodiment of the present invention.

Referring to FIG. 5, the graphical user interface 500 for receiving a title of an audio annotation album includes an input field 510, a character board 520, a previous button 530a, and a next button 530b. A user can input the title of a desired audio annotation album in the input field 510.

A character button (not shown) provided in the apparatus or a direction button (not shown) or an electronic pen (not shown) which is used to select a character on the character board 520 may be used as an input device.

When the previous button 530a is selected, the display module 274 displays a previous screen in which a user can newly select either the creation item or the management item.

When the next button 530b is selected, the display module 274 displays a next screen which allows the user to select a multimedia content file corresponding to the audio annotation album.

Before the next screen is displayed in response to the input of the next button 530b, the basic audio annotation file 300 may be created. Thereafter, the basic audio annotation file 300 is updated in subsequent stages of selecting a multimedia content file and inputting a playing time, a playing sequence, an audio file, and the like.

FIG. 6 illustrates a graphical user interface which receives a selection command for a multimedia content file according to an exemplary embodiment of the present invention. Referring to FIG. 6, the graphical user interface 600 includes an audio annotation album title 610, a multimedia content selection region 620 allowing a user to select a multimedia content file corresponding to the audio annotation album, a playing time setting region 630 allowing the user to set a playing time, a playing sequence setting region 640 allowing the user to set a playing sequence, a search button 628, and a recording start button 650.

The multimedia content selection region 620 includes thumbnails 622 and check boxes 624 for the respective thumbnails 622. The user can check multimedia content files through the thumbnails 624 and add multimedia content files to the audio annotation album by checking corresponding check boxes. In addition, the multimedia content selection region 620 includes a scroll bar 626 to allow the user to search thumbnails that are not shown on a current screen.

When the screen changes from the graphical user interface 500 shown in FIG. 5 to the graphical user interface 600 shown in FIG. 6, the audio annotation file 300 may be created. Here, the thumbnails 622 displayed in the multimedia content selection region 620 may refer to multimedia content files included in a directory in which the audio annotation file 300 is created.

Here, the search button 628 is provided to allow the user to search multimedia content files in other directories. When the search button 628 is selected, thumbnails for multimedia content files included in a different directory are displayed in the multimedia content selection region 620 so that the user can select multimedia content files in different directories.

To allow the user to automatically or manually set a playing time for a multimedia content file, the playing time setting region 630 includes radio buttons for automatic and manual modes, respectively. The user can select either the automatic mode or manual mode. When the user selects the automatic mode, the user can set a playing time for each multimedia content file using a list box 632 displaying automatic playing time.

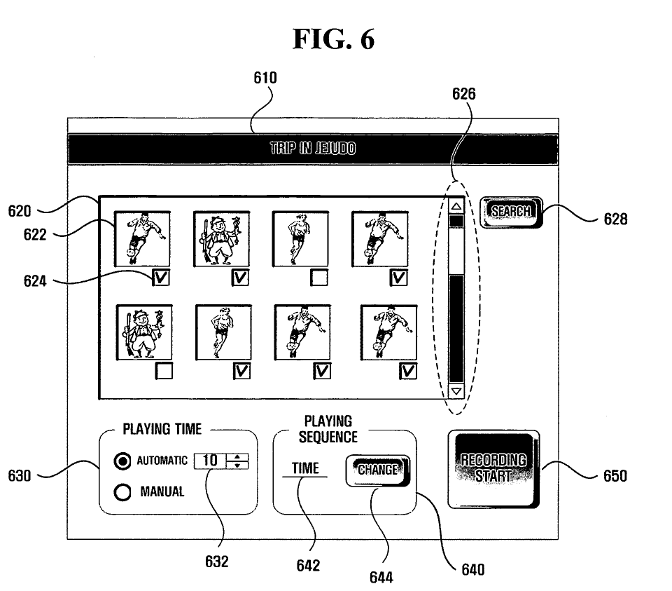

To allow the user to set a playing sequence of a multimedia content file, a current playing sequence type 642 is displayed in text and a change button 644 allowing the user to change the playing sequence type 642 is provided in the playing sequence setting region 640. The playing sequence type 642 may be a sequence of time, size, name, format or a customized sequence. The changing of the playing sequence type 642 will be described with reference to FIG. 7 later.

The user can start recording an audio file for a multimedia content file by selecting the recording start button 650. An input audio is converted into digital data and then added to the audio annotation file 300.

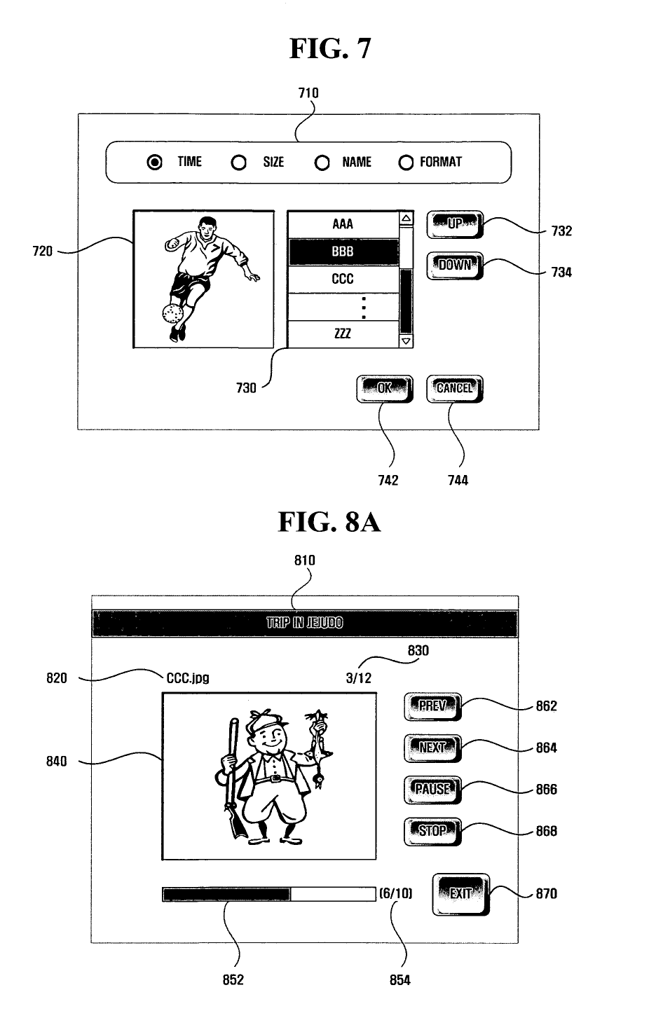

The recording of an audio file will be described in detail with reference to FIGS. 8A and 8B later.

FIG. 7 illustrates a graphical user interface which receives a setup command for a playing sequence of multimedia content files according to an exemplary embodiment of the present invention. The graphical user interface 700 is displayed when the change button 644 in the playing sequence setting region 640 is selected.

The graphical user interface 700 includes a playing sequence type region 710, a multimedia content file display region 720, a multimedia content file list region 730 for the customized sequence, sequence change buttons, that is, an up button 732 and a down button 734, an OK button 742, and a cancel button 744.

The playing sequence type region 710 includes radio buttons for respective sequence types. The sequence types may be time, size, name, and format and the user can select one of the sequence types.

When the user selects the format as the sequence type, multimedia content files are ordered according to their time. The apparatus checks the extension of each multimedia content file, arranges the multimedia content files in ascending or descending alphabetical order, and displays the file names of the multimedia content files in the multimedia content list region 730 in the selected playing sequence.

When the user selects the format as the sequence type, multimedia content files are ordered according to their size. The apparatus checks the extension of each multimedia content file, arranges the multimedia content files in ascending or descending alphabetical order, and displays the file names of the multimedia content files in the multimedia content list region 730 in the selected playing sequence.

When the user selects the format as the sequence type, multimedia content files are ordered according to their name. The apparatus checks the extension of each multimedia content file, arranges the multimedia content files in ascending or descending alphabetical order, and displays the file names of the multimedia content files in the multimedia content list region 730 in the selected playing sequence.

When the user selects the format as the sequence type, multimedia content files are ordered according to their formats (for example, a still image, a moving picture, and an extension). The apparatus checks the extension of each multimedia content file, arranges the multimedia content files in ascending or descending alphabetical order, and displays the file names of the multimedia content files in the multimedia content list region 730 in the selected playing sequence.

By way of suggestion, the sequences of time, size, name, and format are automatically set and the user can change these sequences. For example, the file names of the multimedia content files are displayed in the multimedia content list region 730 in the playing sequence selected by the user from among the playing sequence types. Thereafter, the user can change the playing sequence of particular multimedia content file using the sequence change buttons 732 and 734. For example, when the user selects a multimedia content file having a file name of BBB in the multimedia content list region 730 and then clicks on the up button 732, the file named BBB moves up above a file named AAA. As a result, the file BBB precedes the file AAA in the playing sequence. Similarly, the file BBB may be set to follow a file CCC using the down button 734.

A thumbnail corresponding to a multimedia content file selected in the multimedia content list region 730 is displayed in the multimedia content display region 720. The user can set the customized playing sequence referring to thumbnails displayed in the multimedia content display region 720.

After setting the playing sequence, the user can store the changed playing sequence in the audio annotation file 300 by clicking on the OK button 742. If the user clicks on the cancel button 744, the playing sequence set on the graphical user interface 700 is cancelled. When the OK button 742 or the cancel button 744 is clicked on, the graphical user interface 700 changes into the graphical user interface 600 shown in FIG. 6.

FIG. 8A illustrates graphical user interfaces displayed during audio file recording according to an exemplary embodiment of the present invention. The graphical user interface 800a includes an audio annotation album title region 810, a multimedia content region 840, a multimedia content file name region 820, a playing sequence region 830, a playing time region 852, and buttons 862, 864, 866, 868 and 870.

Using the graphical user interfaces 500 through 700 shown in FIGS. 5 through 7, a user can create the basic audio annotation file 300. In the graphical user interface 800a shown in FIG. 8A, the user can add an audio file to the basic audio annotation file 300. Here, the user may add audio files according to a playing sequence specified in the audio annotation file 300.

A title of an audio annotation album specified in the audio annotation file 300 is displayed in the audio annotation album title region 810.

A multimedia content file corresponding to a current playing sequence is displayed in the multimedia content region 840. For example, multimedia content files are displayed according to the playing sequence specified in the audio annotation file 300.

A file name of the multimedia content file corresponding to the current playing sequence is displayed in the multimedia content file name region 820. For example, file names of respective multimedia content files are displayed according to the playing sequence specified in the audio annotation file 300.

A playing sequence of a multimedia content file currently displayed among all multimedia content files specified in the audio annotation file 300 is displayed in the playing sequence region 830.

A time during which an audio file for the currently displayed multimedia content file can be input is displayed in the playing time region 852. For example, the playing time specified in the audio annotation file 300 is displayed. When the playing time is automatically set in the graphical user interface 600 shown in FIG. 6, the playing time is specified in the audio annotation file 300. When the playing time is manually set in the graphical user interface 600, the playing time is specified as a value of −1 in the audio annotation file 300.

When the playing time is set automatically, the playing time may be displayed in seconds and in a format of a progress bar 852, as shown in FIG. 8A. The user can recognize the start and the end of audio recording for the current multimedia content file based on the displayed playing time. A current recorded time and an overall time may be displayed in a format 854 of percentage near the progress bar 852. When the playing time has lapsed, a subsequent multimedia content file is displayed.

Alternatively, when the playing time is set manually, the progress bar 852 is omitted and a time from the start of audio recording to a current recording point may be displayed in seconds. A user can change a screen to a subsequent multimedia content file using a button.

The buttons include a previous button 862, a next button 864, a pause button 866, a stop button 868, and an exit button 870.

When the previous button 862 is selected, a previous multimedia content file in the playing sequence is displayed. For example, when the previous button 862 is selected in a state where a third multimedia content file is displayed, a second multimedia content file is displayed. An audio file may have already been stored for the previous multimedia content file. Here, a user can input a new audio file for the previous multimedia content file.

When the next button 864 is selected, a next multimedia content file in the playing sequence is displayed. For example, when the next button 864 is selected in a state where the third multimedia content file is displayed, a fourth multimedia content file is displayed. The next button 864 may be used to omit an audio file for the third multimedia content file.

Moving to the previous or next multimedia content file using buttons may be performed in a state in which the playing time has been set automatically and a state in which the playing time has been set manually.

When the pause button 866 is selected, audio input pauses for a moment. When the pause button 866 operates, an audio file is not input and the progression of the playing time also pauses. The pause button 866 may be implemented as a toggle button. In other words, when the pause button 866 is selected, the text of the pause button 866 is changed to “cancel pause”. Thereafter, when the “cancel pause” button is selected, the pause is cancelled. When the pause is cancelled, the user can resume audio recording and the playing time also resumes progression.

When the stop button 868 is selected, entire audio input up to a current point is cancelled. Here, corresponding audio data stored in the audio annotation file 300 may be deleted. The stop button 868 may also be implemented as a toggle button. When the stop button 868 is selected, the text thereof is changed to “recording start”. Thereafter, when the “recording start” button is selected, audio input for a multimedia content file is started all over again. In other words, audio input starts from a first multimedia content file in the playing sequence.

When the exit button 870 is selected, audio input is cancelled thereafter. Here, corresponding audio data that has been stored in the audio annotation file 300 may not be deleted. In other words, an audio file that has been input before the exit button 870 is selected may be effectively stored in the audio annotation file 300.

FIG. 8B is a display showed including a caption region on the graphical user interface 800a during audio recording.

The caption region 880 is a text field which displays text that has been stored by a user. In detail, the user can output the content of an audio file to be input for each multimedia content file into a text and store the text in advance to audio input. Then, the text is displayed in the caption region 880. Accordingly, the user can easily input an audio file by reading the text displayed in the caption region 880.

Text may flow from the right to the left side of the caption region 880. Alternatively, entire text for a current multimedia content file may be displayed at a time period.

When the entire text is displayed at a time period, an indicator may be displayed according to the playing time. In detail, when the playing time has been set automatically, the user needs to read the entire text within the predetermined playing time. In this situation, the indicator is displayed on the text so that the user can adjust reading speed.

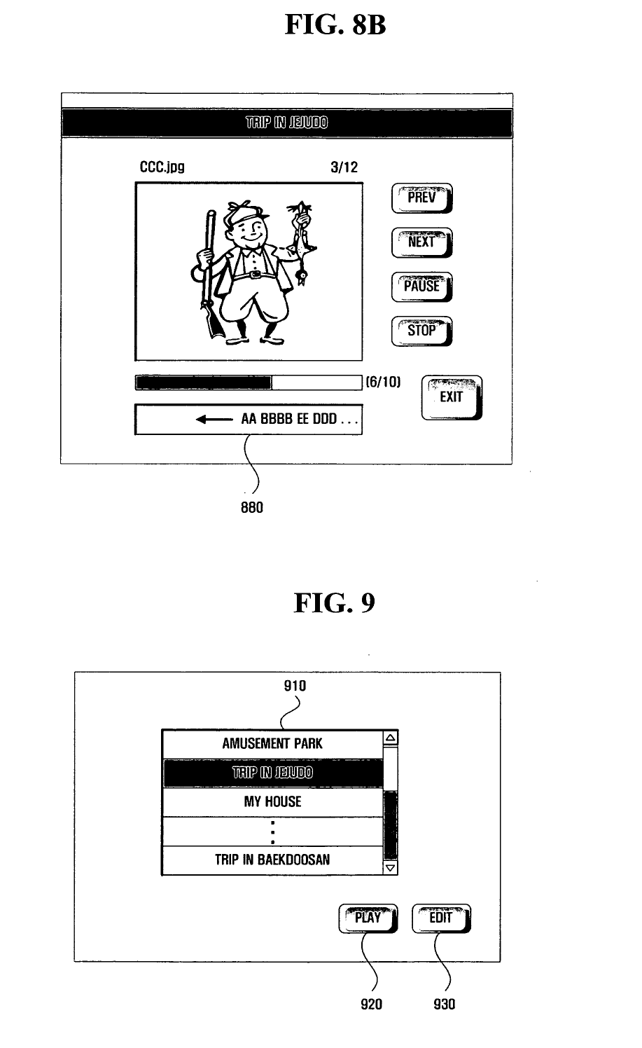

FIGS. 9 through 11 illustrate graphical user interfaces 900, 1000, and 1100 displayed in stages of playing or managing the audio annotation file 300. The graphical user interfaces 900, 1000, and 1100 are displayed when the management item is selected from the command list.

FIG. 9 illustrates a graphical user interface displaying a list of created audio annotation files according to an exemplary embodiment of the present invention. When a user selects one item from a list 910 and clicks on a play button 920, the audio annotation file 300 for the selected item is played so that an audio file stored in the audio annotation file 300 and multimedia content file corresponding to the audio file are played. When the user clicks on an edit button 930 after selecting the item from the list 910, he/she can edit the audio annotation file 300.

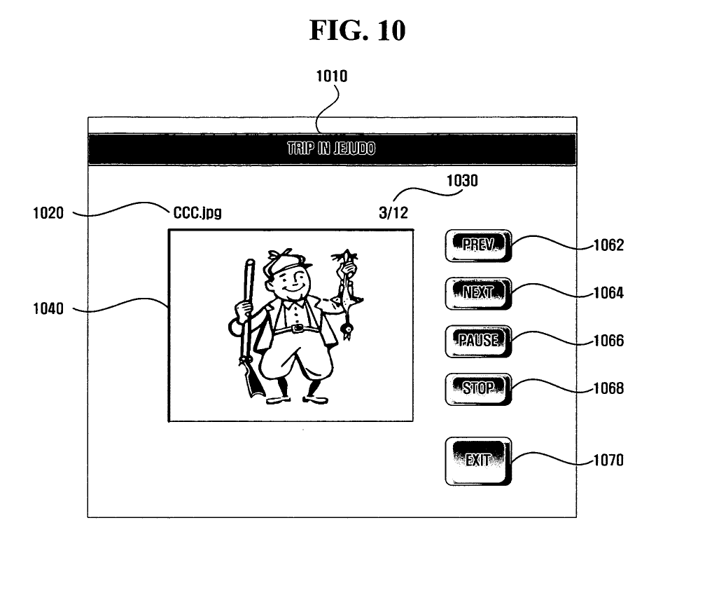

FIG. 10 illustrates a graphical user interface displayed when multimedia content file and audio file is output according to an exemplary embodiment of the present invention. The graphical user interface 1000 includes an audio annotation album title region 1010, a multimedia content region 1040, a multimedia content file name region 1020, a playing sequence region 1030, and buttons, that is, a previous button 1062, a next button 1064, a pause button 1066, a stop button 1068, and an exit button 1070.

A title of an audio annotation album specified in the audio annotation file 300 is displayed in the audio annotation album title region 1010.

A multimedia content file corresponding to a current playing sequence is displayed in the multimedia content region 1040. For example, each multimedia content file is displayed according to a playing sequence specified in the audio annotation file 300. When the multimedia content file is displayed, the apparatus outputs an audio file corresponding thereto. When a predetermined playing time has lapsed since the output of the audio file, a next multimedia content file is displayed.

A file name of the multimedia content file corresponding to the current playing sequence is displayed in the multimedia content file name region 1020. In other words, a file name of each multimedia content file is displayed according to the playing sequence specified in the audio annotation file 300.

A playing sequence of a multimedia content file currently displayed among all multimedia content files specified in the audio annotation file 300 is displayed in the playing sequence region 1030.

When the previous button 1062 is selected, a previous multimedia content file in the playing sequence is displayed and a corresponding audio file is output. For example, when the previous button 1062 is selected in a state where a third multimedia content file is displayed, a second multimedia content file is displayed and a corresponding audio file is output.

When the next button 1064 is selected, a next multimedia content file in the playing sequence is displayed and a corresponding audio file is output. For example, when the next button 1064 is selected in a state where a fourth multimedia content file is displayed, a third multimedia content file is displayed and a corresponding audio file is output.

When the pause button 1066 is selected, the output of a multimedia content file and an audio pause for a moment. The pause button 1066 may be implemented as a toggle button. For example, when the pause button 1066 is selected, the text of the pause button 1066 is changed to “cancel pause”. Thereafter, when the “cancel pause” button is selected, the pause is cancelled. When the pause is cancelled, the output of the multimedia content file and the audio file is resumed.

When the stop button 1068 is selected, the output of a multimedia content file and an audio file stops. The stop button 1068 may be implemented as a toggle button. In other words, when the stop button 1068 is selected, the text of the stop button 1068 is changed to “play”. Thereafter, when the “play” button is selected, the stop is cancelled. When the stop is cancelled, the output of the multimedia content file and the audio file is resumed.

When the exit button 1070 is selected, the output of the multimedia content file and the audio file ends and a screen changes from the graphical user interface 1000 to the graphical user interface 900 shown in FIG. 9 displaying the list 910 of audio annotation files.

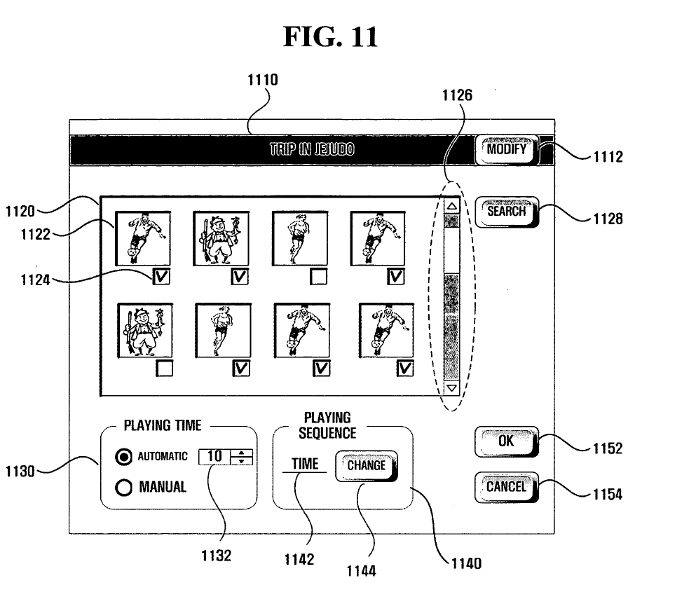

FIG. 11 illustrates a graphical user interface which allows a created audio annotation file to be edited according to an exemplary embodiment of the present invention. The graphical user interface 1100 is displayed when the edit button 930 in the graphical user interface 900 is selected.

The graphical user interface 1100 includes an audio annotation album title region 1110, a multimedia content selection region 1120, a playing time setting region 1130, and a playing sequence setting region 1140.

An audio annotation album title included in the audio annotation file 300 is displayed in the audio annotation album title region 1110. A user can revise the audio annotation album title by clicking on a modify button 1112. When the modify button 1112 is clicked on, a screen may change into the graphical user interface 500 shown in FIG. 5 allowing the user to input an audio annotation album title.

The multimedia content selection region 1120 includes thumbnails 1122 and check boxes 1124 for the respective thumbnails 1122. Check boxes 1124 corresponding to multimedia content files that have already been selected may have been checked. The user can change the state of a check box 1124 corresponding to any multimedia content file based on the thumbnails 1124, thereby creating a new audio annotation album.

In addition, the multimedia content selection region 1120 includes a scroll bar 1126 to allow the user to search thumbnails that are not shown on a current screen.

Predetermined playing time mode and an automatic playing time 1132 are displayed in the playing time setting region 1130. A user can newly select the playing time mode between the automatic mode and the manual mode. When the automatic mode is selected, the automatic playing time 1132 can be reset.

A playing sequence type 1142 that has already been set is expressed in text in the playing sequence setting region 1140. A change button 1144 allowing the user to change the playing sequence type 1142 is provided in the playing sequence setting region 1140. The playing sequence type 1142 may be a sequence of time, size, name, format or a customized sequence. The changing of the playing sequence type 1142 has been described with reference to FIG. 7 above, and thus detailed descriptions thereof will be omitted for clarity and conciseness.

An OK button 1152 and a cancel button 1154 are provided in the graphical user interface 1100. When the OK button 1152 is selected, revision is performed and the revised audio annotation file 300 is stored. When the cancel button 1154 is selected, revision is not performed on the audio annotation file 300.

When the OK button 1152 or the cancel button 1154 is selected, the screen changes to the graphical user interface 900 of FIG. 9 showing the list 910 of audio annotation files.

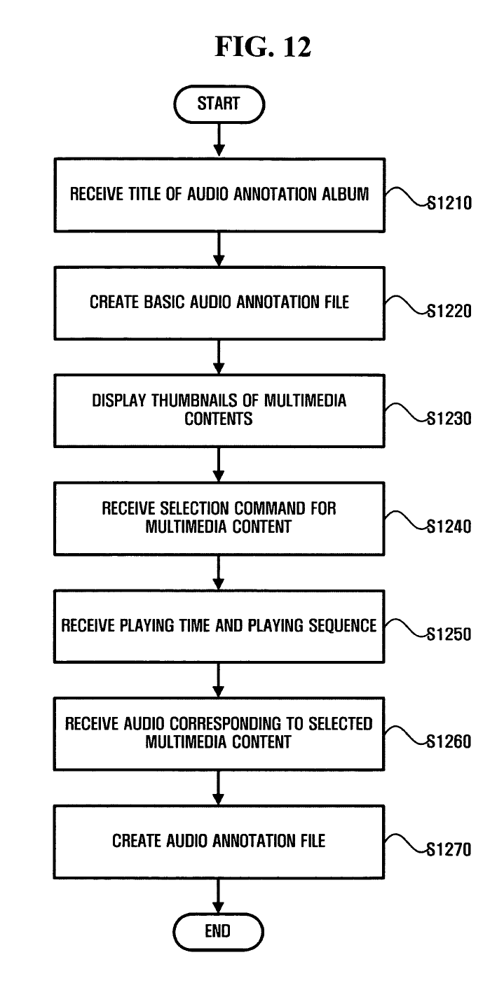

FIG. 12 is a flowchart of a method of creating an audio annotation according to an exemplary embodiment of the present invention.

The apparatus receives a title of an audio annotation album in operation S1210. Here, a user can use character buttons provided in the apparatus to input the title of the audio annotation album or can use direction buttons or an electronic pen to select characters on a character board displayed through the display module 274.

After receiving the title of the audio annotation album, the apparatus creates a basic audio annotation file having the received title as a file name in operation S1220. Here, the basic audio annotation file includes the audio annotation album title, and information for outputting multimedia content file and audio file can be added to the basic audio annotation file.

After receiving the audio annotation album title, the apparatus displays thumbnails of multimedia content files through the display module 274 in operation S1230. Then, the user can select a desired multimedia content file. The apparatus receives a selection command for at least one multimedia content file from the user in operation S1240.

The display module 274 displays a graphical user interface allowing the user to input a playing time and a playing sequence as well as the thumbnails of multimedia content file. The apparatus can also receive selection commands for the playing time and sequence through the graphical user interface in operation S1250.

Here, the playing time may be set automatically or manually. When the playing time is set automatically, the user can input a duration, that is, an automatic playing time.

At least one of a sequence of time, a sequence of size, a sequence of name, a sequence of format, and a customized sequence can be input as the playing sequence.

After the input of the multimedia content file, the playing time, and the playing sequence, the apparatus adds the input information to the basic audio annotation file and receives an audio corresponding to each multimedia content file selected according to the selection command in operation S1260.

The user can input an audio file while watching a multimedia content file displayed through the display module 274. Here, multimedia content files are displayed according to the playing sequence that has been input. In addition, when the playing time has been automatically set, the automatic playing time will be a time during which a single multimedia content file is displayed, that is, an audio file for a single multimedia content file, can be input. For example, when the automatic playing time has been set to 10 seconds, an audio file for each multimedia content file can be input for 10 seconds.

When the playing time has been set manually, a time during which an audio file for a multimedia content file can be input is not restricted. The user can terminate the input of the audio file for a multimedia content file by clicking a next button provided in the apparatus or a graphical user interface and continue the input of an audio file for another multimedia content file.

The input audio is converted into a digital format and then added to the audio annotation file so that the apparatus creates the audio annotation file combining at least one audio in operation S1270.

The created audio annotation file may be revised by the user thereafter. In other words, the user can change the selection of the multimedia content file, the playing time, the playing sequence, and audio data.

When the apparatus includes a display device that can display multimedia content file and an audio file output device that can output audio, the apparatus can output a multimedia content file and a corresponding audio file.

Here, the multimedia content file and the audio file is output according to information on the playing time and the playing sequence which is included in the audio annotation file.

When the audio annotation file and a multimedia content file specified in the audio annotation file are stored in a different apparatus, the multimedia content file can be output through the different apparatus.

As described above, the apparatus and method for creating an audio annotation of the present invention according to exemplary embodiments of the present invention provide at least the following advantages.

First, when a plurality of multimedia content file grouped by a user are displayed, audio files corresponding to the respective multimedia content files are stored in a single file, so that a user can easily produce an audio annotation album for the plurality of multimedia content files related with each other.

Second, since a separate file is created without changing existing multimedia content files when an audio annotation album is produced, a multimedia content file can be easily added to or removed from the audio annotation album.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for creating an audio annotation, comprising:
an interface unit for receiving a selection command for at least one multimedia content file;
an audio input unit for receiving an audio file corresponding to the at least one multimedia content file selected according to the selection command; and
an audio annotation creator for creating an audio annotation file comprising the audio and link information to relate the audio to the at least one multimedia content file.

2. The apparatus of claim 1, wherein the multimedia content file comprises at least one of a still image and a moving picture.

3. The apparatus of claim 1, wherein the audio file has a playing time when included in the audio annotation file.

4. The apparatus of claim 1, wherein the audio file has a different playing time according to the corresponding multimedia content file when included in the audio annotation file.

5. The apparatus of claim 1, further comprising a storage unit for storing the multimedia content file and the audio annotation file.

6. The apparatus of claim 5, wherein the link information is selected from the group consisting of an audio annotation album title, a file name of the multimedia content file, an identification number for the multimedia content file, the audio file corresponding to the multimedia content file, a playing time of the audio, and a playing sequence of the audio.

7. The apparatus of claim 1, further comprising an output unit for outputting the multimedia content file and the audio file corresponding to the multimedia content file.

8. The apparatus of claim 7, wherein the output unit outputs the multimedia content file and the corresponding audio file according to the playing sequence of the audio included in the audio annotation file.

9. The apparatus of claim 7, wherein the output unit outputs the multimedia content file and the corresponding audio file according to the playing time of the audio included in the audio annotation file.

10. A method of creating an audio annotation, comprising:
receiving a selection command for at least one multimedia content file;
receiving an audio file corresponding to the at least one multimedia content file selected according to the selection command; and
creating an audio annotation file comprising the audio and link information to relate the audio to the at least one multimedia content file.

11. The method of claim 10, wherein the multimedia content file comprises at least one of a still image and a moving picture.

12. The method of claim 10, wherein the audio file has a playing time when included in the audio annotation file.

13. The method of claim 10, wherein the audio file has a different playing time according to the corresponding multimedia content file when included in the audio annotation file.

14. The method of claim 10, further comprising storing the multimedia content file and the audio annotation file.

15. The method of claim 14, wherein the link information is selected from the group consisting of an audio annotation album title, a file name of the multimedia content file, an identification number for the multimedia content file, the audio file corresponding to the multimedia content file, a playing time of the audio, and a playing sequence of the audio.

16. The method of claim 10, further comprising outputting the multimedia content file and the audio file corresponding to the multimedia content file.

17. The method of claim 16, wherein the outputting comprises outputting the multimedia content file and the corresponding audio file according to the playing sequence of the audio included in the audio annotation file.

18. The method of claim 16, wherein the outputting comprises outputting the multimedia content file and the corresponding audio file according to the playing time of the audio included in the audio annotation file.

19. A computer readable medium comprising a computer readable program for executing a method of creating an audio annotation, the method comprising:
receiving a title of an audio annotation album;
displaying at least one multimedia content file;
receiving a selection command for the at least one multimedia content file;
receiving an audio file corresponding to the at least one multimedia content file selected according to the selection command;
creating an audio annotation file comprising the received title as a file name comprising audio; and
storing the multimedia content file and the audio annotation file; and
outputting the multimedia content file and the audio file corresponding to the multimedia content file in accordance with the audio annotation file.

20. The method of claim 19, wherein the multimedia content file comprises at least one of a still image and a moving picture.

21. The method of claim 19, wherein the audio file has a playing time when included in the audio annotation file.

22. The method of claim 19, wherein the audio file has a different playing time according to the corresponding multimedia content file when included in the audio annotation file.

23. The method of claim 19, wherein the audio annotation file includes at least one of an audio annotation album title, a file name of the multimedia content file, the number of the multimedia content file, the audio file corresponding to the multimedia content file, a playing time of the audio, and a playing sequence of the audio.

24. The method of claim 19, wherein the outputting comprises outputting the multimedia content file and the corresponding audio file according to the playing sequence of the audio included in the audio annotation file.

25. The method of claim 19, wherein the outputting comprises outputting the multimedia content file and the corresponding audio file according to the playing time of the audio included in the audio annotation file.

26. The apparatus of claim 1, further comprising a graphical user interface for displaying the at least one multimedia content file and outputting audio.

27. The apparatus of claim 26, wherein the graphical user interface comprises:
an audio annotation album title region for displaying a title of an audio annotation album specified in the audio annotation file;
a multimedia content region for displaying the at least one multimedia content file corresponding to a current playing sequence;
a multimedia content file name region for displaying a file name of the at least one multimedia content file corresponding to the current playing sequence;
a playing sequence region for displaying a playing sequence of the at least one multimedia content file currently displayed;
a previous button for selecting in order to display a previous multimedia content file in the playing sequence;
a next button for selecting in order to display a next multimedia content file in the playing sequence;
a pause button for selecting in order to pause the output of a multimedia content file and audio;
a stop button for selecting in order to stop the output of a multimedia content file and audio; and
an exit button for selecting in order to end the output of a multimedia content file and audio, and display a list of created audio annotation files.

28. The apparatus of claim 26, wherein the graphical user interface comprises:
an audio annotation album title region displayed in an audio annotation album title comprised in the audio annotation file;
a modify button for selecting in order to revise the audio annotation album title;
a multimedia content selection region for displaying thumbnails of multimedia content files and check boxes corresponding to multimedia content files for selection;
a playing time setting region for displaying playing time mode and automatic playing time for selection;
a playing sequence setting region for displaying a playing sequence type set;
a change button for selecting in order to change the playing sequence type;
an OK button for selecting in order to store revisions to the audio annotation file and display a list of created audio annotation files; and
a cancel button for selecting in order to not perform revisions to the audio annotation file and display a list of created audio annotation files.

29. The method of claim 10, further comprising displaying the at least one multimedia content file and outputting audio on a graphical user interface.

30. The method of claim 29, wherein the graphical user interface comprises:
an audio annotation album title region for displaying a title of an audio annotation album specified in the audio annotation file;
a multimedia content region for displaying the at least one multimedia content file corresponding to a current playing sequence;
a multimedia content file name region for displaying a file name of the at least one multimedia content file corresponding to the current playing sequence;
a playing sequence region for displaying a playing sequence of the at least one multimedia content file currently displayed;
a previous button for selecting in order to display a previous multimedia content file in the playing sequence;
a next button for selecting in order to display a next multimedia content file in the playing sequence;
a pause button for selecting in order to pause the output of a multimedia content file and audio;
a stop button for selecting in order to stop the output of a multimedia content file and audio; and
an exit button for selecting in order to end the output of a multimedia content file and audio, and display a list of created audio annotation files.

31. The method of claim 29, wherein the graphical user interface comprises:
an audio annotation album title region displayed in an audio annotation album title comprised in the audio annotation file;
a modify button for selecting in order to revise the audio annotation album title;
a multimedia content selection region for displaying thumbnails of multimedia content files and check boxes corresponding to multimedia content files for selection;
a playing time setting region for displaying playing time mode and automatic playing time for selection;
a playing sequence setting region for displaying a playing sequence type set;
a change button for selecting in order to change the playing sequence type;
an OK button for selecting in order to store revisions to the audio annotation file and display a list of created audio annotation files; and
a cancel button for selecting in order to not perform revisions to the audio annotation file and display a list of created audio annotation files.

32. The method of claim 19, further comprising displaying the at least one multimedia content file and outputting audio on a graphical user interface.

33. The method of claim 32, wherein the graphical user interface comprises:
an audio annotation album title region for displaying a title of an audio annotation album specified in the audio annotation file;
a multimedia content region for displaying the at least one multimedia content file corresponding to a current playing sequence;
a multimedia content file name region for displaying a file name of the at least one multimedia content file corresponding to the current playing sequence;
a playing sequence region for displaying a playing sequence of the at least one multimedia content file currently displayed;
a previous button for selecting in order to display a previous multimedia content file in the playing sequence;
a next button for selecting in order to display a next multimedia content file in the playing sequence;
a pause button for selecting in order to pause the output of a multimedia content file and audio;
a stop button for selecting in order to stop the output of a multimedia content file and audio; and
an exit button for selecting in order to end the output of a multimedia content file and audio, and display a list of created audio annotation files.

34. The method of claim 32, wherein the graphical user interface comprises:
an audio annotation album title region displayed in an audio annotation album title comprised in the audio annotation file;
a modify button for selecting in order to revise the audio annotation album title;
a multimedia content selection region for displaying thumbnails of multimedia content files and check boxes corresponding to multimedia content files for selection;
a playing time setting region for displaying playing time mode and automatic playing time for selection;
a playing sequence setting region for displaying a playing sequence type set;
a change button for selecting in order to change the playing sequence type;
an OK button for selecting in order to store revisions to the audio annotation file and display a list of created audio annotation files; and
a cancel button for selecting in order to not perform revisions to the audio annotation file and display a list of created audio annotation files.
